(19) United States
(12) Patent Application Publication
(10) Pub. No.: US 2004/0113955 A1
(43) Pub. Date: Jun. 17, 2004

(54) Mobile information terminal

(76) Inventor: Satoshi Kosugi, Kanagawa (JP)

Correspondence Address: PEARNE & GORDON LLP, 1801 EAST 9TH STREET, SUITE 1200, CLEVELAND, OH, 44114-3108, US

(21) Appl. No.: 10/469,084

(22) PCT Filed: May 23, 2002
(86) PCT No.: PCT/JP02/05016

(30) Foreign Application Priority Data
Jul. 31, 2001 (JP) 2001-231754

(51) Int. Cl. G09G 5/00

(52) U.S. Cl. 345/856

(57) ABSTRACT

An object of the present invention is to provide a portable information terminal which enables the user to move a cursor in a desired direction without erroneous operations and to variably set a cursor moving speed, and is reduced in size and user-friendly with favorable using handiness and excellent operability.

To achieve the above object, a portable information terminal is disclosed in which a cursor displayed on the display section 102 is moved by the direction operation key 109a capable of moving the cursor in every direction. In the portable information terminal, when a direction detecting section 110 detects an operation direction of the direction operation key 109a, a control section 101 then refers to a direction conversion table 112a, and converts an operation direction detected by the direction detecting section 110 to a specific moving direction, with a corresponding relation to a movable direction of the cursor displayed in a operation direction display section 103, and controls a movement of the cursor on the display section 102.

### FIELD OF THE INVENTION

The present invention relates to a portable information terminal is disclosed in which a cursor displayed on display means is moved by the direction operation key capable of moving the cursor in every direction. More particularly, the invention relates to a portable information terminal which enables the user to move a cursor in a desired direction without erroneous operations and to variably set a cursor moving speed, and is reduced in size and user-friendly with favorable using handiness and excellent operability.

### BACKGROUND ART

Recently, a portable information terminal, such as a portable telephone set, increases the number of its use purposes, such as telephone calls, the reference of home pages, for example, on the internet, and others. In this circumstance, it is required that the using handiness and operability of the device are excellent. With the multi-functionality of the portable information terminal, in making a menu selection on screens of multi-layers, a user moves a cursor on a menu displayed on the display screen by operating a direction operation key which is operable in up and down, and right and left directions, and selects a desired item from the items displayed on the menu. To retrieve the contents, e.g., a map, displayed by the menu selection, an image of the map or the like is moved by operating the direction operation key. Switches which are arrayed in, for example, a plurality of directions (up, down, right and left directions), a stick, track ball and the like are known for the direction operation key for such operations.

Where the portable information terminal is used for a multiple of purposes, if the direction operation key is operated in the upper and lower right and left directions as well as the four directions, or the up, down and right and left directions, the function selection and retrieval will be more easily carried out.

However, in the portable information terminal, the device size reduction as well as the multi-functionality is highly required. In this sense, it should be avoided to increase the size of the direction operation key. If the number of operation directions of the direction operation key is increased to be 8 directions or larger, when the direction operation key is small in size, the following erroneous operation sometimes occur. Although the user operates the key with the intention to operate it in the vertical directions, the use's finger actually touches the direction operation key in an oblique direction and the cursor moves in an oblique direction. Thus, it is difficult for the user to operate the key as intended, possibly causing erroneous operations. As a result, the device operability is further deteriorated.

Accordingly, an object of the present invention is to provide a portable information terminal which enables the user to move a cursor in a desired direction without erroneous operations and to variably set a cursor moving speed, and is reduced in size and user-friendly with favorable using handiness and excellent operability.

### DISCLOSURE OF THE INVENTION

To solve the problems mentioned above, there is provided a portable information terminal in which a cursor displayed on the display section is moved by the direction operation key capable of moving the cursor in every direction. The portable information terminal comprises: a direction detecting means for detecting an operation direction of the direction operation key; operation direction display means for displaying a movable direction of the is cursor; and control means for converting an operation direction detected by the direction detecting means to a specific moving direction, with a corresponding relation to a movable direction of the cursor displayed in the operation direction display means, and controls a movement of the cursor on the display means.

In an embodiment of the invention, the portable information terminal comprises movable direction select means for selecting a movable direction of the cursor displayed operation direction display means.

In another embodiment, the portable information terminal further comprises a direction conversion table for converting an operation direction detected by the direction detecting means to a specific moving direction, with a corresponding relation to a movable direction of the cursor displayed in the operation direction display means.

In an additional embodiment, the portable information terminal, when the control means converts an operation direction detected by the direction detecting means to a specific moving direction, the control means varies a moving speed of the cursor on the display means in accordance with an angular difference between those two directions.

A further embodiment, the portable information terminal further comprises speed setting/selecting means for selecting a movable direction of the cursor displayed in the operation direction display means and specifying a movable direction of the cursor whose moving speed is to be varied.

In another embodiment, the portable information terminal a speed setting table for setting a moving speed of the cursor in accordance with an angular difference between an operation direction detected by the direction detecting means and a specific direction of the cursor on the display means.

In still another embodiment, the portable information terminal further comprises an operation key table containing plural kinds of tables each consisting of the direction conversion table or a combination of the direction conversion table and the speed setting table; and a direction indicator select key for selecting one of the direction conversion table or the combination of the direction conversion table and the speed setting table.

In a further embodiment, the portable information terminal further comprises operation means for varying a moving speed of the cursor on the display means in accordance with an operation time or the number of operations of the operation means.

As described above, the portable information terminal in which a cursor displayed on a display means is moved and selected by a direction operation key capable of moving the cursor in every direction, is arranged such that when direction detecting means detects an operation direction of the direction operation key, a control section converts an operation direction detected by the direction detecting means to a specific moving direction, with a corresponding relation to a movable direction of the cursor displayed in operation direction display means, and controls a movement of the cursor on the display section. With the cursor movement control, even if the direction operation key is operated in any direction, the cursor moves only in the movable direction displayed in the operation direction display means. Accordingly, the invention successfully provides realizes a portable information terminal advantageously featured in that even when the size-reduced direction operation key is used, the user can move the cursor in a desired direction without erroneous operations, the device size is reduced, and the device is user-friendly with favorable using handiness and excellent operability.

In an embodiment of the invention, movable direction select means selects a movable direction of the cursor displayed operation direction display means. Accordingly, the user can specify a cursor movable direction in accordance with use purpose, the contents of the display and the like. As a result, the portable information terminal is excellent in using handiness and operability.

In another embodiment, the portable information terminal further comprises a direction conversion table for converting an operation direction detected by the direction detecting means to a specific moving direction, with a corresponding relation to a movable direction of the cursor displayed in the operation direction display means. With this feature, the process carried out by the control means is simple. When the direction conversion table is presented on the display screen or the contents of the direction conversion table is edited by the user, the portable information terminal is excellent in using handiness and operability.

In another embodiment, when the control means converts an operation direction detected by the direction detecting means to a specific moving direction, the control means varies a moving speed of the cursor on the display means in accordance with an angular difference between those two directions. With this characteristic feature, the user varies the moving speed of the cursor in accordance with the operation direction (input angle) of the direction operation key. Further, the user can move the cursor in accordance with use purpose, the contents of the display and the like such that the user makes a quick key operation, or when the cursor is finely position adjusted, the user makes the key operation slow. Accordingly, the portable information terminal which is excellent in using handiness and operability is realized.

In a further embodiment, speed setting/selecting means selects a movable direction of the cursor displayed in the operation direction display means and specifies a movable direction of the cursor whose moving speed is to be varied. With this, the user can specify a cursor movable direction in accordance with use purpose, the contents of the display and the like, and hence, the using handiness and operability of the device are improved.

In an additional embodiment, the portable information terminal further comprises a speed setting table for setting a moving speed of the cursor in accordance with an angular difference between an operation direction detected by the direction detecting means and a specific direction of the cursor on the display means. The control means refers to the speed setting table and controls a moving speed of the cursor displayed on the display means. With this feature, the process carried out by the control means is simple. When the speed setting table is presented on the display screen or the contents of the speed setting table is edited by the user, the portable information terminal is excellent in using handiness and operability.

In another embodiment of the invention, the portable information terminal further comprises: an operation key table containing plural kinds of tables each consisting of the direction conversion table or a combination of the direction conversion table and the speed setting table. One of the direction conversion table or the combination of the direction conversion table and the speed setting table is selected by a direction indicator select key, and is supplied to the cursor movement control by the control means. With this feature, from the plural cursor movable direction indicators and the cursor moving speed patterns, a desired pattern may be selected. Accordingly, the user can set a cursor movable direction and a cursor moving speed in accordance with use purpose, the contents of the display and the like. As a result, the using handiness and operability of the device are improved.

In an additional embodiment, the portable information terminal further comprises operation means for varying a moving speed of the cursor on the display means in accordance with an operation time or the number of operations of the operation means. For example, when special keys as the direction indicator select key and the fixing key are used as operation means, a moving speed of the cursor is set in accordance with a key operation time or the number of clicking operations. Thus, the user varies the moving speed of the cursor. Accordingly, the user can move the cursor in accordance with use purpose, the contents of the display and the like such that the user makes a quick key operation, or when the cursor is finely position adjusted, the user makes the key operation slow. As a result, the portable information terminal which is excellent in using handiness and operability is realized.

### BRIEF DESCRIPTION OF THE DRAWINGS

FIG. 1 is a block diagram showing an arrangement of a portable information terminal according to a first embodiment of the invention.

FIG. 2(a) is a diagram showing an outward appearance of the portable information terminal of the embodiment, and FIG. 2(b) is an explanatory diagram showing an exemplar display on an operation direction display section used when a cursor movable direction is selected.

FIG. 3 is a diagram showing an exemplar direction conversion table of an operation key table retained in a memory.

FIG. 4 is a flow chart showing operation of the portable information terminal of the first embodiment.

FIG. 5 is a block diagram showing an arrangement of a portable information terminal according to a second embodiment of the invention.

FIG. 6(a) is a diagram showing an exemplar direction conversion table of an operation key table retained in a memory, and FIG. 6(b) is a diagram showing an exemplar speed setting table.

FIG. 7 is a flow chart showing operation of the portable information terminal of the second embodiment.

In the figure, reference numeral 100 is a portable information terminal; 101 is a control section (CPU); 102 is a display section; 103 is an operation direction display section; 104 is an antenna; 105 is a speaker; 106 is a microphone; 108 is an operation section; 109a is a direction operation key; 109b is a fixed key; 109c is a direction indicator select key; 110 is a direction detecting part; 111 is a storage section; 112 is an operation key table; 112a is a direction conversion table; 112b is a speed setting table; 113 is a transceiving section; 114 is a voice processing section; 115 is a display control section; and 116 is a signal processing section.

### BEST MODES FOR CARRYING OUT THE INVENTION

Portable information terminals which are embodiments of the invention will be described with reference to the accompanying drawings. Description will be given in the order of (First Embodiment) and (Second Embodiment).

(First Embodiment)

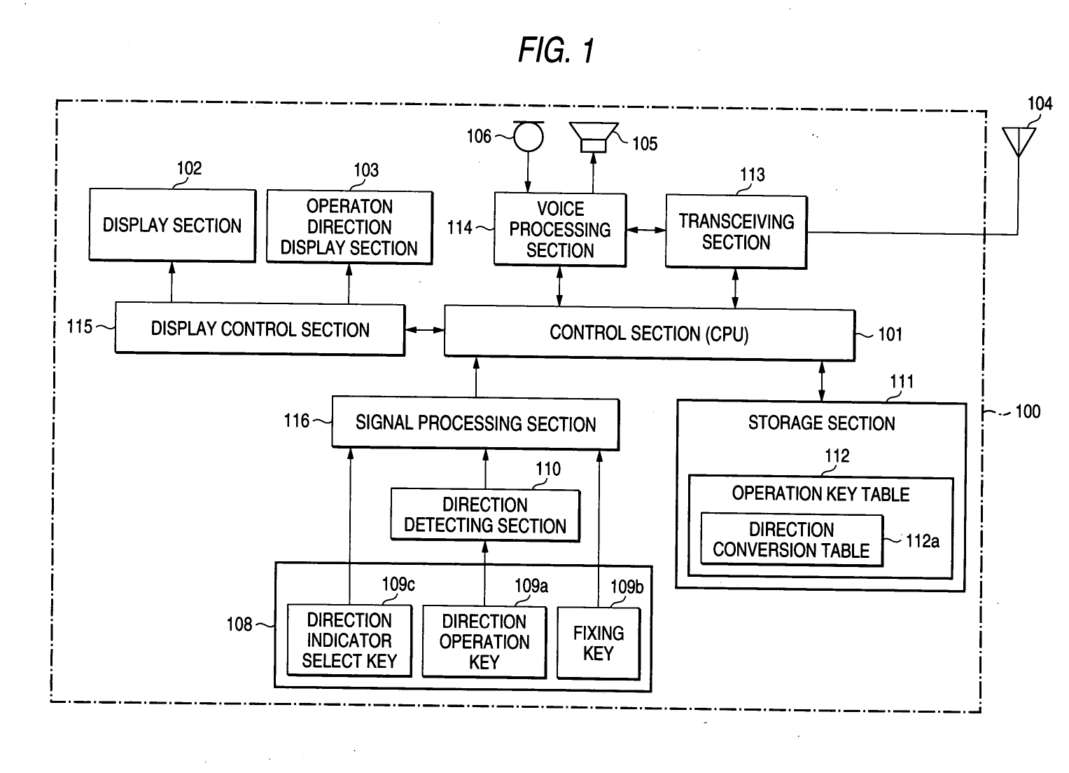

FIG. 1 is a block diagram showing an arrangement of a portable information terminal according to a first embodiment of the invention.

In FIG. 1, a portable information terminal 100 of the instant embodiment is made up of a control section (CPU) 101, a display section 102, an operation direction display section 103, an antenna 104, a speaker 105, a microphone 106, an operation section 108 including at least a direction operation key 109a, a fixing key 109b and a direction indicator select key 109c, a direction detecting section 110, a storage section 111 including an operation key table 112, a transceiving section 113, a voice processing section 114, a display control section 115, and a signal processing section 116.

The voice processing section 114, which is connected to the speaker 105 and the microphone 106, performs, for example, speech communication through the transceiving section 113 connected to the antenna 104 under control of the control section 101. Further, the control section 101 may, for example, make an access to internet home pages or the like, through the transceiving section 113. Electronic configurations to realize those normal wireless communication functions are well known, and hence description of the details of them is omitted here.

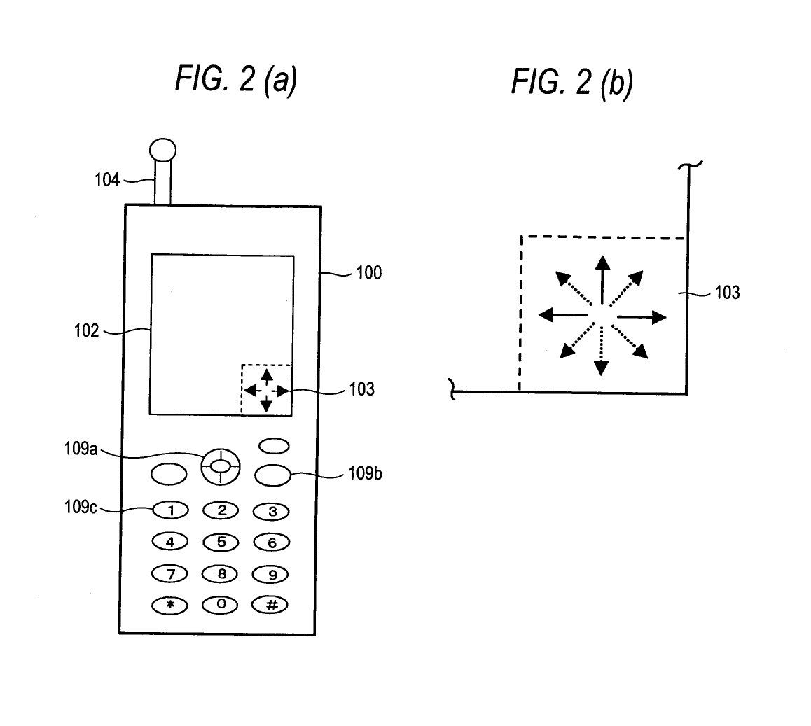

FIG. 2(a) is a diagram showing an outward appearance of the portable information terminal 100 of the embodiment. As shown, the portable information terminal includes the display section 102, which takes the form of an LCD panel, and the operation section 108 having the direction operation key 109a, the fixing key 109b and the direction indicator select key 109c. The speaker 105 is located in an upper part of the display section 102, and the microphone 106 is located in a lower part of the operation section 108. The illustration of those is omitted in FIG. 2(a).

The display section 102 displays text data containing characters and numerals, and image data (map information, stock price information, etc.). A sectional area, which is located in the lower right corner in a display area of the display section 102, and enclosed by a broken line, indicates the operation direction display section 103. Cursor movable directions of a cursor to be displayed on the display section 102 are displayed in the form of arrows in the operation direction display section 103. The operation direction display section 103 may always be presented at a predetermined position on the display section 102, or may be presented, whenever occasion calls, according to a display setting by a user. The operation direction display section 103 may be located at a desired position on the display section 102 according to a setting by the user.

The direction operation key 109a of the operation section 108 corresponds to a direction operation key, which is used in CLAIMS. By operating the direction operation key 109a, a cursor that is displayed on the display section 102 may be moved in a direction corresponding to a movable direction (any of, for example, up, down, right and left, upper right and left and the lower right and left). Specifically, for the operation direction of the direction operation key 109a, its input angle θ is detected by the direction detecting part. A signal represented by the detected input angle is processed by the signal processing section 116. Then, the display section 102 determines a moving direction of the cursor, while referring to the operation key table 112 (direction conversion table 112a) of the storage section 111. Then, the cursor is moved on the display section 102 under control of the display control section 115.

The fixing key 109b is used such that in selecting any of various operations, the user selects a desired operation, and presses the fixing key 109b to fix the selected operation. The direction indicator select key 109c is used when the cursor movable direction is selected, for example, when the up- and down-directions and right- and left-directions are switched to the upper right- and left-directions and the lower right- and left-directions, and vice versa. The display direction in the operation direction display section 103 is switched over in link with the depression of the direction indicator select key 109c.

The storage section 111 may take the form of, for example, volatile and non-volatile memories (RAM, ROM, EEPROM, flash memory) Programs to be executed and handled by the control section 101 are stored in the storage section 111. The operation key table 112 including the direction conversion table 112a is stored in the storage section 111. The direction conversion table 112a converts an operation direction (input angle θ) of the direction operation key 109a to a specific moving direction with a corresponding relation to a movable direction of the cursor displayed in the operation direction display section 103. The direction operation key 109a may be operated in every direction, and the control section 101 converts refers to the direction conversion table 112a to carry out the conversion, whereby the input angle θ within a predetermined range (operation of the direction operation key 109a) is converted into a cursor movement in the specific direction.

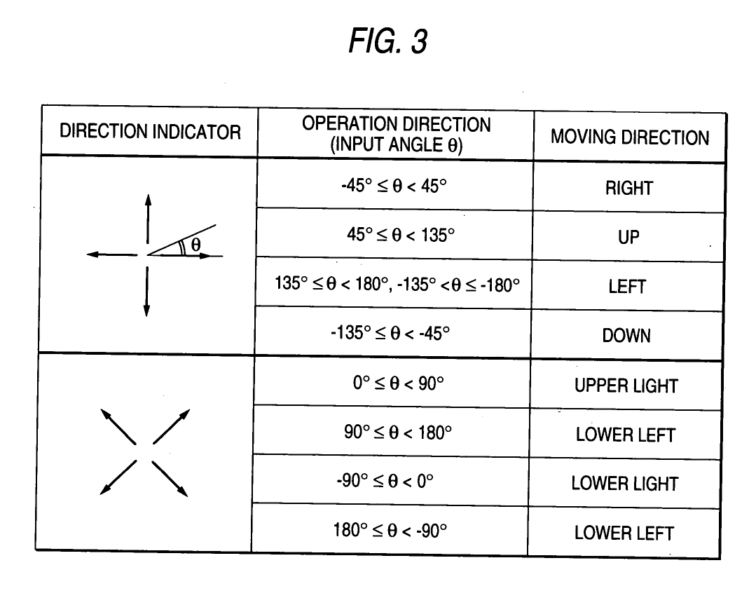

FIG. 3 is a diagram showing the exemplar direction conversion table 112a of the operation key table 112 retained in the storage section 111. The direction conversion table 112a contains a plurality of cursor movable direction indicators. In FIG. 3, a direction conversion table is shown which contains four directions of up, down, right and left directions, and four directions of the upper right and left directions, and lower right and left directions. The moving direction of the cursor on the display section 102 is specified according to the operation direction (input angle θ) of the direction operation key 109a. In a case where the cursor movable directions are four, i.e., up, down, right and left directions, when the input angle θ is within a range from −45° to +45°, the input angel is converted into 0, i.e., θ=0°, and the cursor moves in the rightward direction. When the input angle θ is within a range from +45° to 135°, the input angle is converted into 90° and the cursor moves in the upward direction.

The user selects a desired cursor movable direction indicator from those stored in the direction conversion table 112a, and sets it by use of the direction indicator select key 109c. The control section 101 sequentially selects the cursor movable direction indicators in the direction conversion table 112a in link with the depression of the direction indicator select key 109c. At the same time, the direction indicator in the operation direction display section 103 is also changed over to the direction indicator of the cursor movable direction pattern selected.

The cursor movable direction indicators may be selected one by one by the user. This indicates that a movable direction of the cursor displayed on the operation direction display section 103 is selected by movable direction select means. The movable direction select means may be another key (not shown in FIG. 1) on the operation section 108 or the direction indicator select key 109c may also be used for the movable direction select means. A cursor movable direction may be selected in a manner that, as shown in FIG. 2(b), a plurality of direction indicators (eight directions indicated by broken lines in the drawing) are displayed in the operation direction display section 103, and the user selects a desired movable direction (arrow indicated by a solid line in the figure). In this case, when a conversion table for the conversion between an input angle θ for the cursor movable direction indicator selected by the user and the moving direction exists, such a table is used for the moving direction selection. When the input angle θ/moving direction conversion table does not exist, the user may edit and form the conversion table or the control section 101 may automatically form the table. Further, the existing input angle θ and moving direction conversion table may also be presented on the display screen and the user may edit the contents of the table.

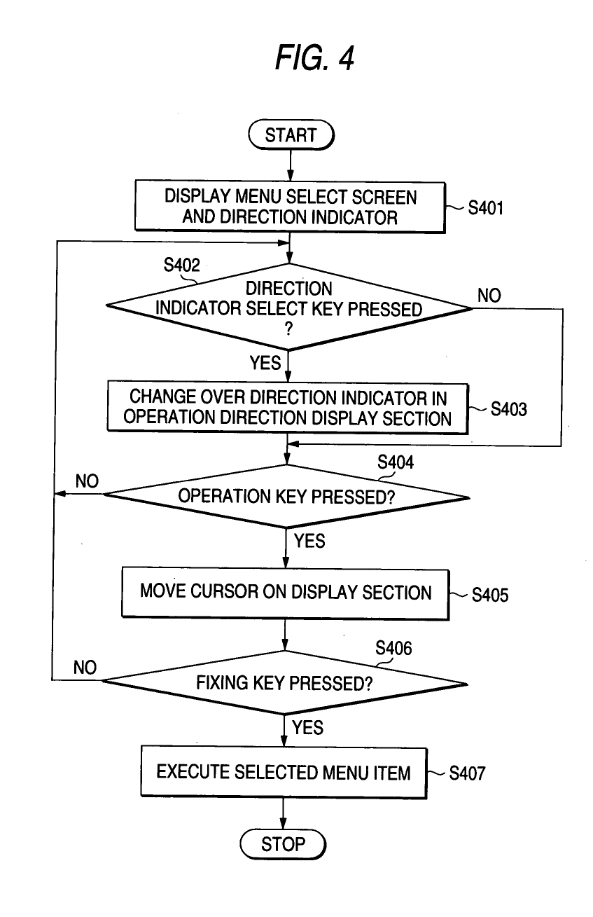

Operation of the portable information terminal of the instant embodiment will be described with reference to a flow chart shown in FIG. 4. In an initial state (step S401), a menu select screen containing a list of items is being displayed in the display section 102. As shown in FIG. 2(a), the operation direction display section 103 is located in a display region at the lower right corner on the display section 102.

In a step S402, the control section or CPU checks if the direction indicator select key 109c of the operation section 108 is pressed. When the direction indicator select key 109c is pressed, a step S403 is executed to switch over the cursor movable direction indicator in the direction conversion table 112a to that to be used by the control section 101, and the direction indicator in the operation direction display section 103 is switched over. When the direction indicator select key 109c is not pressed, the CPU advances to a step S404.

Then, the S404 is executed to check if the direction operation key 109a is operated. If the direction operation key 109a is not operated, the CPU returns to the step S402. If it is operated, the CPU advances to a step S405. The step S405 is executed and an operation direction (input angle θ) of the direction operation key 109a is detected by the direction detecting section 110. And, the CPU refers to the direction conversion table 112a (cursor movable direction indicator selected) in the operation key table 112 to determine a cursor moving direction, and moves the cursor on the display section 102 through the control of the display control section 115.

Thereafter, the CPU checks if the fixing key 109b is pressed. Specifically, the user puts the cursor on a desired item in the menu select screen, and presses the fixing key 109b. The portable information terminal side detects the key depression, and executes the menu item in the step S407. When the fixing key 109b is not pressed (step S406), the CPU returns to the step S402.

As described above, in the portable information terminal in which a cursor displayed on the display section 102 is moved by the direction operation key 109a capable of moving the cursor in every direction, when the direction detecting section 110 detects an operation direction of the direction operation key 109a, the control section 101 then converts the operation direction detected by the direction detecting section 110 to a specific moving direction, with a corresponding relation to the movable direction of the cursor displayed in the operation direction display section 103, and controls a movement of the cursor on the display section 102. With the cursor movement control, even if the direction operation key 109a is operated in any direction, the cursor moves only in the movable direction displayed in the operation direction display section 103. Accordingly, the invention successfully realizes the portable information terminal advantageously featured in that even in a structure where the direction operation key 109a is reduced in size, the user can move the cursor in a desired direction without erroneous operations, the device size is reduced, and the device is user-friendly with favorable using handiness and excellent operability.

The control section 101 controls the movement of the cursor displayed on the display section 102 while referring to the direction conversion table 112a. In an alternative, the direction conversion table 112a is displayed on the display section 102, or the user, for example, edits the contents of the direction conversion table 112a in the alternative, the using handiness and operability are much more improved.

Also in the portable information terminal, one cursor movable direction indicator is selected from those stored in the direction conversion table 112a by use of the direction indicator select key 109c, and the selected one is supplied to the cursor movement control. With this feature, from the plural cursor movable direction indicators a desired pattern may be selected. Accordingly, the user can set a cursor movable direction and a cursor moving speed in accordance with use purpose, the contents of the display and the like. As a result, the using handiness and operability of the device are improved.

A cursor movable direction displayed in the operation direction display section 103 is selected by use of, for example, the direction indicator select key 109c as movable direction select means, whereby the user can specify a cursor movable direction in accordance with use purpose, the contents of the display and the like, and hence, the using handiness and operability of the device are improved.

Further, by using, as operation means, such special keys as the direction indicator select key 109c and the fixing key 109b, a moving speed of the cursor on the display section 102 may be varied in accordance with a key operation time or the number of key operations. This may be implemented such that moving speed data is added to the direction conversion table 102a so that the cursor moves at high speed in a direction within a changed direction range by continuing the depression of the direction indicator select key 109c for a fixed time or longer or by double clicking when the cursor movable direction indicator in the operation direction display section 103 is changed over to another by use of the direction indicator select key 109c. Such an implementation enables one to change the setting of the cursor moving speed as well as the cursor moving direction. With this feature, the user can change the cursor moving speed such that he makes a quick operation in accordance with use purpose, the contents of the display and the like, or makes slow the key operation when the cursor is finely positioned. Accordingly, the portable information terminal which is excellent in using handiness and operability is realized.

(Second Embodiment)

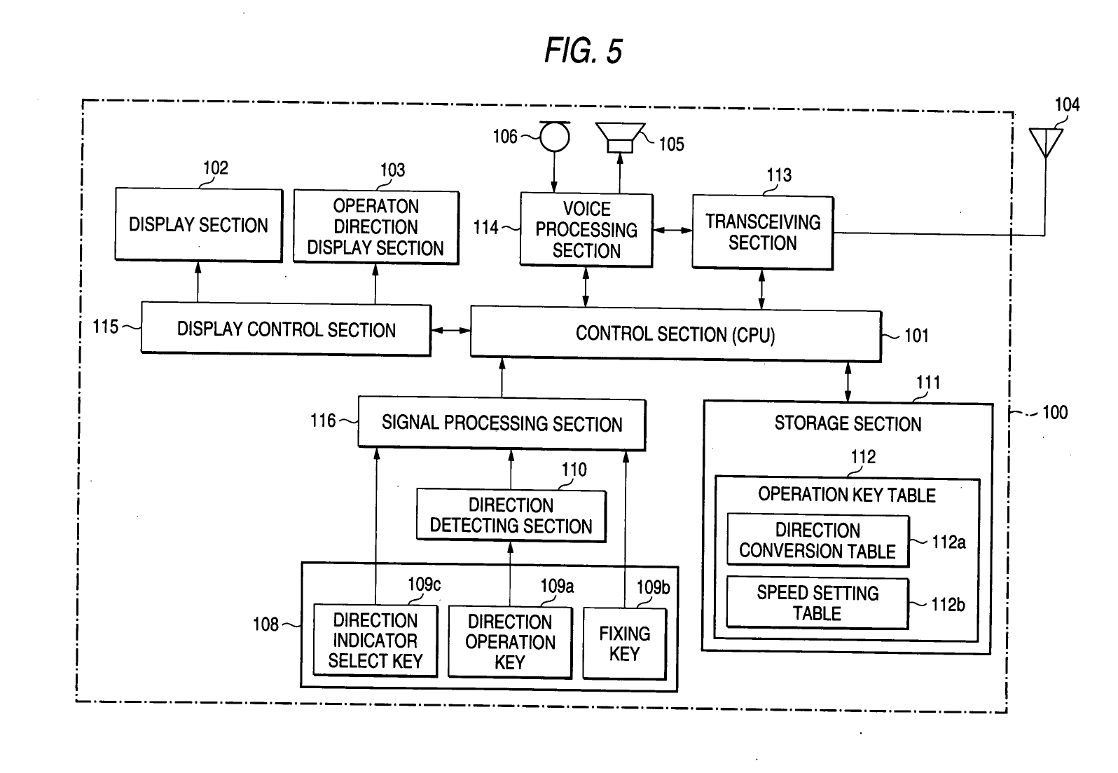

FIG. 5 shows an arrangement of a portable information terminal according to a second embodiment of the invention. An arrangement of the portable information terminal of the instant embodiment is substantially the same as that of the first embodiment (see FIG. 1) except that a direction conversion table 112a and a speed setting table 112b is contained in the operation key table 112 in the storage section 111. In FIG. 5, description of the same components as those in the first embodiment (see FIG. 1) is omitted.

The portable information terminal of the second embodiment, like that of the first embodiment, has such a function that an operation direction of the direction operation key 109a is converted into a specific moving direction with a corresponding relation to a movable direction of the cursor displayed in the operation direction display section 103, where by a moving direction of the cursor is controlled on the display section 102. Further, the second embodiment has characteristically such a function as to vary the moving speed of the cursor depending on an angular difference φ between two directions, an operation direction of the direction operation key 109a and a cursor moving direction.

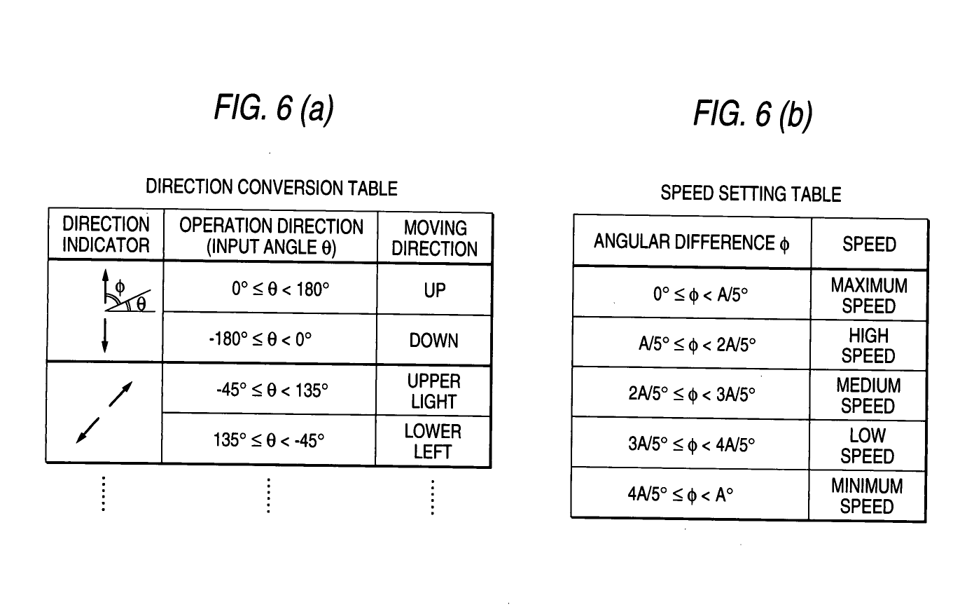

FIGS. 6(a) and 6(b) exemplarily show the direction conversion table 112a (FIG. 6(a)) and a speed setting table 112b (FIG. 6(b)) in the operation key table 112 retained in the storage section 111. The direction conversion table 112a, as in the first embodiment (FIG. 3), includes a plurality of cursor movable direction patterns, and in FIG. 6(a), a direction conversion table contains two types of direction indicator, a first type of direction indicator consisting of two cursor movable direction pattern of up-and-down-directions, and a second type of direction indicator consisting of two cursor movable direction pattern of upper-right-and-lower-left-directions. A moving direction of the cursor on the display section 102 is specified depending on an operation direction (input angle θ) of the direction operation key 109a.

The user sets which of the cursor movable direction indicators in the direction conversion table 112a is used, by use of the direction indicator select key 109c.

The control section 101 successively selects the cursor movable direction indicators in the direction conversion table 112a, while linking with the depression of the direction indicator select key 109c. At the same time, the direction indicator in the operation direction display section 103 is also changed to the direction indicator of the selected cursor movable direction pattern.

For the cursor movable direction indicators, the movable directions may be selected one by one by the user. For example, as in the first embodiment (see FIG. 2(b)), a movable direction may be selected from a plurality of direction indicators in the operation direction display section 103. Further, the cursor movable direction patterns shown in FIG. 6(a) may be selected in a manner that when the cursor movable direction indicators of the four directions which are the up, down, and right and left directions shown in FIG. 3 are selected, the two directions of the up and down or the right and left directions are selected from the four directions. In this case, when a conversion table for the conversion between an input angle θ for the cursor movable direction indicator selected by the user and the moving direction exists, such a table is used for the moving direction selection. When the input angle θ/moving direction conversion table does not exist, a conversion table is presented on the display section 102, the user may edit and form the conversion table or the control section 101 may automatically form the table. The existing input angle θ and moving direction conversion table may also be presented on the display screen and the user may edit the contents of the table.

The speed setting table 112b of FIG. 6(b) varies the cursor moving speed from minimum to maximum in five steps in accordance with an angular difference φ between the operation direction of the direction indicator select key 109c and the converted cursor moving direction. “A” indicates a variable varying in accordance with the cursor movable direction indicator. When the cursor movable direction indicators of two directions, the up and down or right and left directions are selected, the angular difference is 90°. When the cursor movable direction indicators of the four directions, the up and down directions and the upper right and left directions, are selected, it is 45°. The table of FIG. 6(b) is designed such that when the angular difference φ is small, the cursor moving speed is high, and as the angular difference φ increases, the cursor moving speed becomes lower. It should be understood that the variation of the cursor moving speed is not limited, but is optional inclusive of the number of steps.

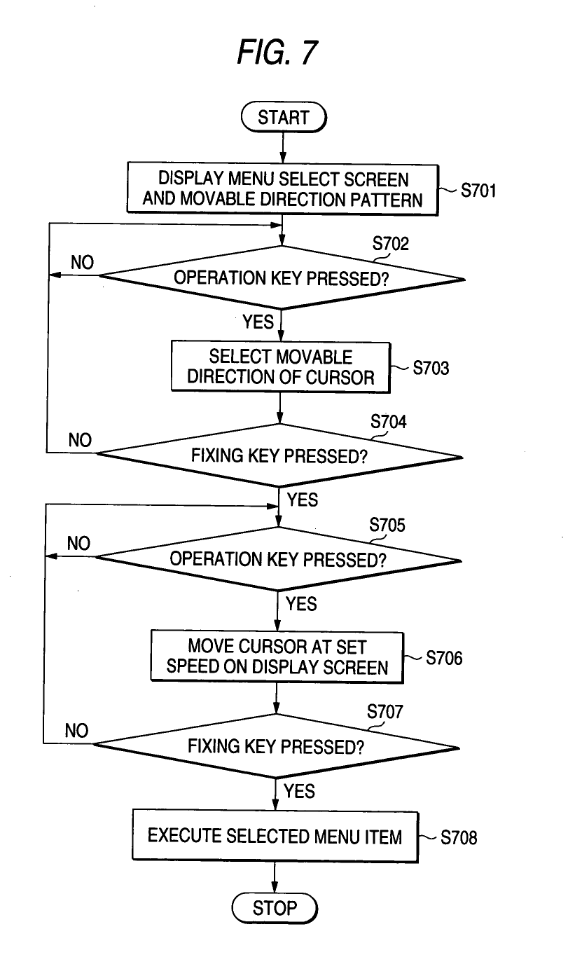

Operation of the portable information terminal of the instant embodiment will be described with reference to a flowchart shown in FIG. 7. In an initial state (step S701), a menu select screen containing a list of items is presented in the display section 102. The operation direction display section 103, which is located at the lower right corner on the display section 102, is used for selecting a cursor moving direction as shown in FIG. 2(b). A movable direction select mode may be set up by the menu selection or by pressing a specific key.

In a step S702, the control section or CPU checks if the direction operation key 109a of the operation section 108 is pressed. When the direction operation key 109a is pressed, the user selects a movable direction of the cursor in a step S703. Specifically, the user makes the round of the movable directions (arrows indicated by dotted lines) by use of the direction operation key 109a, and selects a desired movable direction by pressing the direction indicator select key 109c. In this case, when a conversion table for the conversion between an input angle θ for the cursor movable direction indicator selected by the user and the moving direction exists, such a table is used for the moving direction selection. When the input angle θ/moving direction conversion table does not exist, a conversion table is presented on the display section 102, the user may edit and form the conversion table or the control section 101 may automatically form the table.

And, in a step S704, the CPU checks if the fixing key 109b is pressed. If the fixing key 109b is pressed, the CPU judges that the cursor movable direction indicator is selected and fixed, and advances to a step S705. If the direction operation key 109a is not pressed in the step S702 and the fixing key 109b is not pressed in the step S704, the CPU returns to the step S702.

Next, in the step S705, the CPU checks if the direction operation key 109a is pressed. The CPU continues the judgment till the direction operation key 109a is operated, and if the direction operation key 109a is operated, the CPU advances to a step S706. The step S706 is executed and an operation direction (input angle θ) of the direction operation key 109a in the operation key table 112 is detected by the direction detecting section 110. And, the CPU refers to the direction conversion table 112a (cursor movable direction indicator selected) in the operation key table 112 to determine a cursor moving direction. The CPU refers to the speed setting table 112b, and sets a cursor moving speed to a predetermined speed in accordance with an angular difference φ between the operation direction of the direction operation key 109a and moves the cursor on the display section 102 at the set moving speed in the converted moving direction, through the control of the display control section 115.

Thereafter, the CPU checks if the fixing key 109b is pressed. Specifically, the user puts the cursor on a desired item in the menu select screen, and presses the fixing key 109b. The portable information terminal side detects the key depression, and executes the menu item in the step S708. When the fixing key 109b is not pressed (step S707), the CPU returns to the step S705.

As described above, in the portable information terminal in which a cursor displayed on the display section 102 is moved by the direction operation key 109a capable of moving the cursor in every direction, when the direction detecting section 110 detects an operation direction of the direction operation key 109a, the control section 101 then converts the operation direction detected by the direction detecting section 110 to a specific moving direction, with a corresponding relation to the movable direction of the cursor displayed in the operation direction display section 103. And, the control section refers to the speed setting table 112b, and sets a cursor moving speed to a predetermined speed in accordance with an angular difference φ between the operation direction of the direction operation key 109a and the converted cursor moving direction, and moves the cursor on the display section 102 at the set moving speed in the converted moving direction, through the control of the display control section 115.

With the cursor movement control, even if the direction operation key 109a is operated in any direction, the cursor moves only in the movable direction displayed in the operation direction display section 103. Accordingly, the invention successfully realizes the portable information terminal advantageously featured in that even in a structure where the direction operation key 109a is reduced in size, the user can move the cursor in a desired direction without erroneous operations, the device size is reduced, and the device is user-friendly with favorable using handiness and excellent operability. Further, by finely adjusting the operation direction of the direction operation key 109a, the moving speed of the cursor may be varied. With this feature, the user can change the cursor moving speed such that he makes a quick operation in accordance with use purpose, the contents of the display and the like, or makes slow the key operation when the cursor is finely positioned. Accordingly, the portable information terminal which is excellent in using handiness and operability is realized.

A cursor movable direction displayed in the operation direction display section 103 is selected by using the direction operation key 109a and the direction indicator select key 109c as movable direction select means, whereby the user can specify a cursor movable direction in accordance with use purpose, the contents of the display and the like, and hence, the using handiness and operability of the device are improved.

In the first and second embodiments, a button switch of the depression type as shown in FIG. 2(a) is used for the direction operation key 109a operable in every direction. The direction operation key may take any of other forms than the button switch, viz., it may be of the stick type, track ball type, and a touch pad type.

The following arrangement may be employed, if necessary. A key is disposed at the central part of those keys, and the direction operation key 109a is used selectively as the fixing key 109b or the direction indicator select key 109c, through the operation of the switch. In a specific example, the direction operation key 109a is used as the direction indicator select key 109c by a normal clicking operation of the switch. The direction operation key 109a is used as the fixing key 109b by double clicking the switch. If so done, the number of kinds of the keys in the operation section 108 is reduced, and the device size reduction is realized.

While the invention has been described in detail and using specific embodiments, it will be apparent to those skilled in the art that various changes, alteration, modification and variations may be made without departing from the spirit or scope of the invention.

This application is based on Japanese Patent Application Nos. 2001-231754, filed Jul. 31, 2001, the contents of which are incorporated herein by reference.

### INDUSTRIAL APPLICABILITY

As seen from the foregoing description, a portable information terminal in which a cursor displayed on a display means is moved and selected by a direction operation key capable of moving the cursor in every direction, is arranged such that when direction detecting means detects an operation direction of the direction operation key, a control section, converts an operation direction detected by the direction detecting means to a specific moving direction, with a corresponding relation to a movable direction of the cursor displayed in operation direction display means, and controls a movement of the cursor on the display section. With the cursor movement control, even if the direction operation key is operated in any direction, the cursor moves only in the movable direction displayed in the operation direction display means. Accordingly, the invention successfully provides realizes a portable information terminal advantageously featured in that even when the size-reduced direction operation key is used, the user can move the cursor in a desired direction without erroneous operations, the device size is reduced, and the device is user-friendly with favorable using handiness and excellent operability.

In an embodiment of the invention, movable direction select means selects a movable direction of the cursor displayed operation direction display means. Accordingly, the user can specify a cursor movable direction in accordance with use purpose, the contents of the display and the like. As a result, the portable information terminal is excellent in using handiness and operability.

In another embodiment, when the control means converts an operation direction detected by the direction detecting means to a specific moving direction, the control means varies a moving speed of the cursor on the display means in accordance with an angular difference between those two directions. With this characteristic feature, the user varies the moving speed of the cursor in accordance with the operation direction (input angle) of the direction operation key. Further, the user can move the cursor in accordance with use purpose, the contents of the display and the like such that the user makes a quick key operation, or when the cursor is finely position adjusted, the user makes the key operation slow. Accordingly, the portable information terminal which is excellent in using handiness and operability is realized.

In a further embodiment, speed setting/selecting means selects a movable direction of the cursor displayed in the operation direction display means and specifies a movable direction of the cursor whose moving speed is to be varied. The user can specify a cursor movable direction in accordance with use purpose, the contents of the display and the like, and hence, the using handiness and operability of the device are improved.

The portable information terminal also includes an operation key table containing plural kinds of tables each consisting of a direction conversion table for converting an operation direction detected by the direction detecting means to a specific moving direction, or a combination of the direction conversion table and a speed setting table for setting a moving speed of the cursor in accordance with an angular difference between an operation direction detected by the direction detecting means and a specific direction of the cursor on the display means. In the arrangement, one of the direction conversion table or the combination of the direction conversion table and the speed setting table is selected by a direction indicator select key, and is supplied to the cursor movement control by the control means. With this feature, from the plural cursor movable direction indicators and the cursor moving speed patterns, a desired pattern may be selected. Accordingly, the user can set a cursor movable direction and a cursor moving speed in accordance with use purpose, the contents of the display and the like. As a result, the using handiness and operability of the device are improved.

1. A portable information terminal, in which a cursor displayed on the display section is moved by the direction operation key capable of moving the cursor in every direction,
said portable information terminal comprising:
a direction detecting means for detecting an operation direction of the direction operation key;
operation direction display means for displaying a movable direction of said cursor; and
control means for converting an operation direction detected by said direction detecting means to a specific moving direction, with a corresponding relation to a movable direction of said cursor displayed in said operation direction display means, and controls a movement of the cursor on said display means.

2. The portable information terminal according to claim 1, further comprising:
movable direction select means for selecting a movable direction of said cursor displayed operation direction display means.

3. The portable information terminal according to claim 1 or 2, further comprising:
a direction conversion table for converting an operation direction detected by said direction detecting means to a specific moving direction, with a corresponding relation to a movable direction of said cursor displayed in said operation direction display means.

4. The portable information terminal according to any of claims 1 to 3,
wherein when said control means converts an operation direction detected by said direction detecting means to a specific moving direction, said control means varies a moving speed of said cursor on said display means in accordance with an angular difference between those two directions.

5. The portable information terminal according to claim 4, further comprising:
speed setting/selecting means for selecting a movable direction of said cursor displayed in said operation direction display means and specifying a movable direction of said cursor whose moving speed is to be varied.

6. The portable information terminal according to claim 4 or 5, further comprising:
a speed setting table for setting a moving speed of said cursor in accordance with an angular difference between an operation direction detected by said direction detecting means and a specific direction of said cursor on said display means.

7. The portable information terminal according to any of claim 4 or 5, further comprising:
an operation key table containing plural kinds of tables each consisting of said direction conversion table or a combination of said direction conversion table and said speed setting table; and
a direction indicator select key for selecting one of said direction conversion table or the combination of said direction conversion table and said speed setting table.

8. The portable information terminal according to any of claims 1 to 7, further comprising:
operation means for varying a moving speed of said cursor on said display means in accordance with an operation time or the number of operations of the operation means.
